(19) United States
(12) Patent Application Publication
(10) Pub. No.: US 2010/0293280 A1
(43) Pub. Date: Nov. 18, 2010

(54) Device and method for processing packets

(75) Inventor: Daisuke Namihira, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/805,240

(22) Filed: Jul. 20, 2010

Related U.S. Application Data
(63) Continuation of application No. PCT/JP2008/051575, filed on Jan. 31, 2008.

(51) Int. Cl. G06F 15/173

(52) U.S. Cl. 709/226

(57) ABSTRACT

A packet processing device includes a memory unit that includes a plurality of areas each corresponding to a type of communication that is used for packet transmission, a plurality of processing units that is provided in correspondence with the type of communication and performs a process on the packet, an allocating unit that allocates a processing target packet to the processing unit corresponding to the type of communication that is used for transmission of the processing target packet, an assigning unit that assigns the area corresponding to the type of communication that is used for transmission of the processing target packet to the processing unit to which the processing target packet is allocated, and a storage unit that stores information on the process of the processing target packet and information on the type of communication that is used for transmission of the processing target packet in the assigned area.

### CROSS-REFERENCE TO RELATED APPLICATION

This application is a continuation of International Application No. PCT/JP2008/051575, filed on Jan. 31, 2008, the entire contents of which are incorporated herein by reference.

### FIELD

The embodiment discussed herein is directed to a device and a method for processing packets.

### BACKGROUND

In general, a relay device such as a switch or a router is provided between a server and a client in a computer network to perform a process of relaying a packet. A conventional relay device performs only layer 2 (data link layer) and layer 3 (network layer) processes in OSI (Open Systems Interconnection) reference model. However, a higher-layer process can be recently performed by a relay device in some cases. Specifically, there is appearing a relay device that performs a high-layer process such as a load distribution process for distributing a load for a server, a fire wall process for preventing the attack from the outside, or a VPN process such as IPsec (Security Architecture for Internet Protocol) or SSL-VPN (Secure Socket Layer-Virtual Private Network) for concealing communication between a client and a server. Furthermore, because a relay device can perform the analysis for a high layer, the relay device can perform a QoS (Quality of Service) process on the basis of high-layer information in some cases.

A device generally referred to as a network server, which performs both processes of a high-layer process and layer 2 and layer 3 processes, is further arranged in a computer network. Because the network server has a concentrated load in the network due to the multiple functions of the server, the network server requires high performance in terms of a basic performance. For this reason, because a relaying process performed by the network server does not include a complicated process that much, a high-speed process can be performed by realizing the relaying function as hardware. On the other hand, because a high-layer process performed by the network server includes a complicated process and requires flexible function enhancement corresponding to a new service, a high-speed process cannot be performed by simply realizing the function as hardware. Therefore, the high speed of a software process, that is, the improvement of a performance of CPU (Central Processing Unit) is desirable for speeding up the high-layer process performed by the network server.

In recent years, because the performance of a single CPU substantially approaches the limit, the high speed of a software process can be planned by mounting a plurality of CPUs and CPU cores (hereinafter, “CPU”) on a single device. At this time, simply making the plurality of CPUs execute the same process cannot achieve the high speed of a software process. Therefore, when a plurality of packets that is a processing target arrives at a network server, the packets are assigned to the plurality of CPUs and the CPUs concurrently process the packets. However, because most of conventional software is implemented on the assumption that the flow of a process is single, there is a possibility that a malfunction occurs when the process is concurrently carried out by the plurality of CPUs. Because the main cause of the malfunction is that the plurality of CPUs accesses a memory that is used by software, the information of the memory used by one CPU is rewritten by another CPU and thus internal inconsistency is caused.

Therefore, for example, as illustrated in FIG. 1, it is considered to set n areas, which correspond to CPUs 10-1 to 10-n (n is an integer number of two or more), in a storage area of a memory 20 and to separately store information used by the CPUs 10-1 to 10-n in the areas respectively corresponding to the CPUs. By doing so, because each of the CPUs 10-1 to 10-n accesses the corresponding area of the memory 20, the internal inconsistency can be prevented. However, when such a memory configuration is employed, information (hereinafter, “shared information”) that is commonly used by the CPUs 10-1 to 10-n is stored in all the areas of the memory 20, and thus a capacity required by the memory 20 increases.

Therefore, while one CPU accesses the shared information, an exclusion process is performed for prohibiting another CPU from accessing the same information. Specifically, for example, as illustrated in FIG. 2, a lock variable is added to the shared information stored in the memory 20. For example, while the CPU 10-1 accesses the shared information, the shared information is locked by the lock variable and the other CPUs 10-2 to 10-n are prohibited from accessing the shared information. Then, when the access to the shared information performed by the CPU 10-1 terminates, the locking of shared information by the lock variable is released and the access to the shared information performed by the other CPUs 10-2 to 10-n is permitted. By doing so, internal inconsistency caused by simultaneously accessing shared information by the plurality of CPUs can be prevented.

For example, Japanese Laid-open Patent Publication No. 06-19858 discloses a technique for preventing a plurality of processors from simultaneously using the same shared resource by using shared resource management information for managing a shared resource such as a memory. The technique can also realize an exclusion process for shared information stored in a shared resource.

However, because another CPU cannot access shared information while one CPU accesses the shared information when the exclusion process described above is performed, the process of the other CPU may be stopped. As a result, even if a plurality of CPUs concurrently executes a process, there is a problem in that the improvement of the performance of a device has limitations. Specifically, although it is considered that a performance theoretically has two times when the number of CPUs increases to two times, the performance cannot actually arrive at two times because an exclusion process occurs between CPUs. In extreme cases, a performance may decrease compared with before the number of CPUs becomes two times. Therefore, to improve a performance, it is desirable to reduce the frequency of an exclusion process.

In particular, in a network server, because relayed packet information (hereinafter, “packet information”), connection information of packet transmission (hereinafter, “connection information”), or the like is stored in a common buffer as shared information that is used by all CPUs, it is difficult to improve the performance of a network server if an exclusion process frequently occurs. Therefore, it is highly desirable to reduce the frequency of an exclusion process.

To avoid an exclusion process, it is preferable that processes are allocated to a plurality of CPUs in such a manner that only one CPU accesses each piece of shared information. In other words, for example, if processes are allocated in a network server so that one packet among packets stored in a buffer is processed by only one CPU, an exclusion process can be avoided without the competition between accesses to packet information.

However, even if processes are allocated to a plurality of CPUs in this way, the acquisition and release of a buffer used by the plurality of CPUs to execute a packet process still require an exclusion process. In other words, each CPU refers to connection information and the like when processing a packet, and hence, each CPU needs to access information of managing a buffer that stores necessary connection information to acquire or release the buffer. As a result, because the plurality of CPUs necessarily accesses the information of managing the buffer, an exclusion process is performed between CPUs.

### SUMMARY

According to an aspect of an embodiment of the invention, a packet processing device includes: a memory unit that includes a plurality of areas each corresponding to a type of communication that is used for transmission of a packet; a plurality of processing units that is provided in correspondence with the type of communication and performs a process on the packet; an allocating unit that allocates a processing target packet to the processing unit corresponding to the type of communication that is used for transmission of the processing target packet; an assigning unit that assigns the area corresponding to the type of communication that is used for transmission of the processing target packet to the processing unit to which the processing target packet is allocated; and a storage unit that stores information on the process of the processing target packet and information on the type of communication that is used for transmission of the processing target packet in the assigned area.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 is a diagram illustrating an example of a method for preventing internal inconsistency in parallel processing;

FIG. 2 is a diagram illustrating another example of a method for preventing internal inconsistency in parallel processing;

FIG. 3 is a block diagram illustrating a schematic configuration of a packet processing device according to an embodiment;

FIG. 4 is a block diagram illustrating an internal configuration of a CPU section according to the embodiment;

FIG. 5 is a block diagram illustrating an internal configuration of a memory according to the embodiment;

FIG. 6 is a diagram illustrating a specific exemplary configuration of a FIFO unit according to the embodiment;

FIG. 7 is a diagram illustrating an example of a connection information table according to the embodiment;

FIG. 8 is a flowchart illustrating an operation of the packet processing device according to the embodiment;

FIG. 9 is a flowchart illustrating an operation of a parallel processing CPU when releasing a buffer according to the embodiment;

FIG. 10 is a flowchart illustrating an operation of an allocating CPU when releasing a buffer according to the embodiment; and

FIG. 11 is a block diagram illustrating an example of a connection information table according to another embodiment.

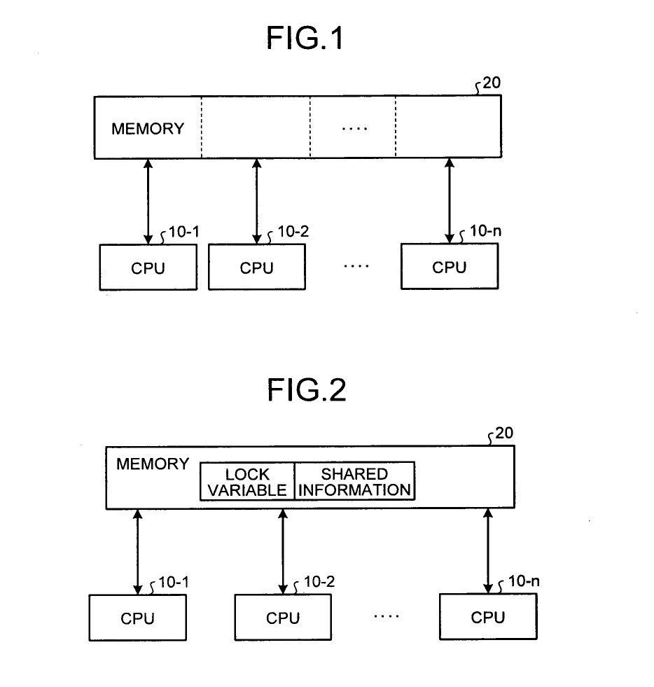

### DESCRIPTION OF EMBODIMENTS

Preferred embodiments of the present invention will be explained with reference to accompanying drawings. The main point of the present invention is that a processor that allocates a process for a packet to a plurality of CPUs together performs the assignment and release of a buffer area required for the execution of the process in addition to the allocation of the process. The present invention is not limited to the embodiments explained below.

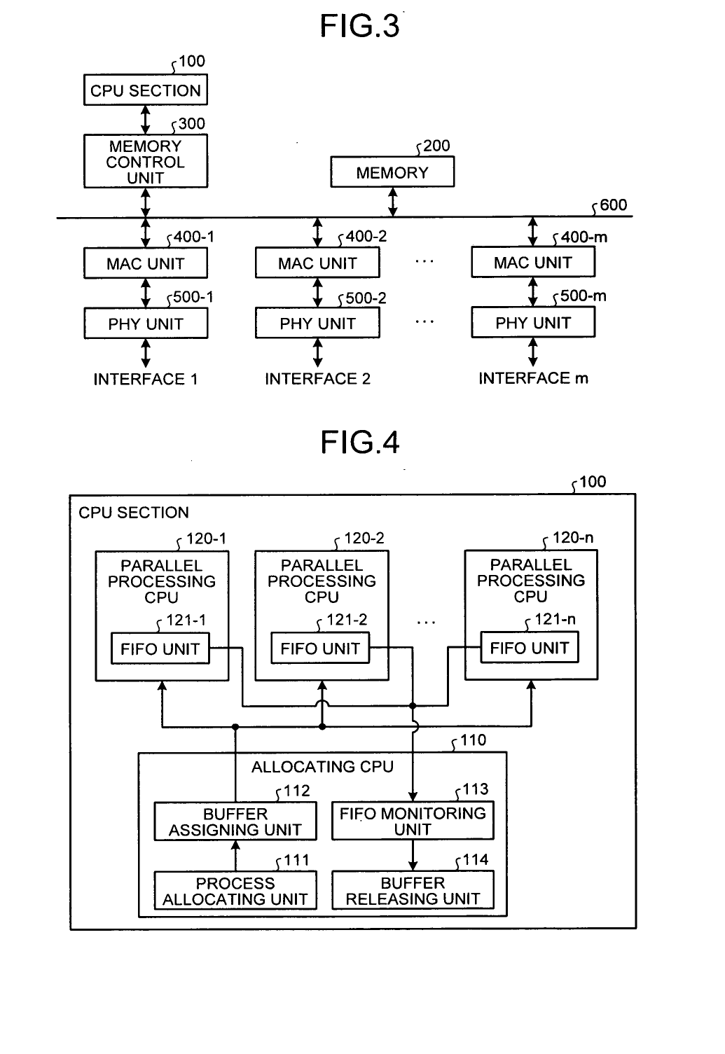

FIG. 3 is a block diagram illustrating a schematic configuration of a packet processing device according to an embodiment of the present invention. The packet processing device illustrated in FIG. 3 is, for example, mounted on a relay device such as a network server. Furthermore, the packet processing device may be mounted on a terminal device such as a server or a client. The packet processing device illustrated in FIG. 3 includes a CPU section 100, a memory 200, a memory control unit 300, MAC (Media Access Control) units 400-1 to 400-m (m is an integer number of one or more, PHY (PHYsical) units 500-1 to 500-m, and an internal bus 600.

The CPU section 100 includes a plurality of CPUs and each CPU executes a process by using information stored in the memory 200. At this time, the CPUs of the CPU section 100 concurrently execute different processes. The CPU section 100 further includes a CPU that allocates processes to the plurality of CPUs that concurrently executes the processes. The allocating CPU executes the assignment and release of buffer area for the process.

The memory 200 includes a buffer that stores information that is used for the process performed by each CPU of the CPU section 100. Specifically, the memory 200 includes buffers that respectively store information (packet information) included in a packet input from the outside, information (connection information) for connection used for the transmission of a packet, and the like. Moreover, the memory 200 stores the status of a vacancy of each buffer.

The memory control unit 300 controls the exchange of information between the CPU section 100 and the memory 200 when the CPU section 100 executes the processes by using the information stored in the memory 200. In other words, the memory control unit 300 acquires necessary information from the memory 200 via the internal bus 600 and provides the information to the CPU section 100 when the processes are executed by the CPU section 100.

The MAC units 400-1 to 400-m execute a partial process of the layer 2 for setting a transmission and reception method or an error detection method of a packet. Similarly, the PHY units 500-1 to 500-m are respectively connected to an external interface 1 to an external interface m and execute a process of the layer 1 (physical layer). The MAC units 400-1 to 400-m and the PHY units 500-1 to 500-m are integrally formed on, for example, a network card for each combination (for example, the combination of the MAC unit 400-1 and the PHY unit 500-1) of the corresponding two processing units. Packets are input through the interfaces 1 to m into the packet processing device via the MAC units 400-1 to 400-m and the PHY units 500-1 to 500-m, and packets are output from the packet processing device through the interfaces 1 to m.

The internal bus 600 connects the processing units inside the packet processing device to transmit information. Specifically, the internal bus 600 transmits, for example, packet information input from the interfaces 1 to m from the MAC units 400-1 to 400-m to the memory 200 or transmits the packet information from the memory 200 to the memory control unit 300.

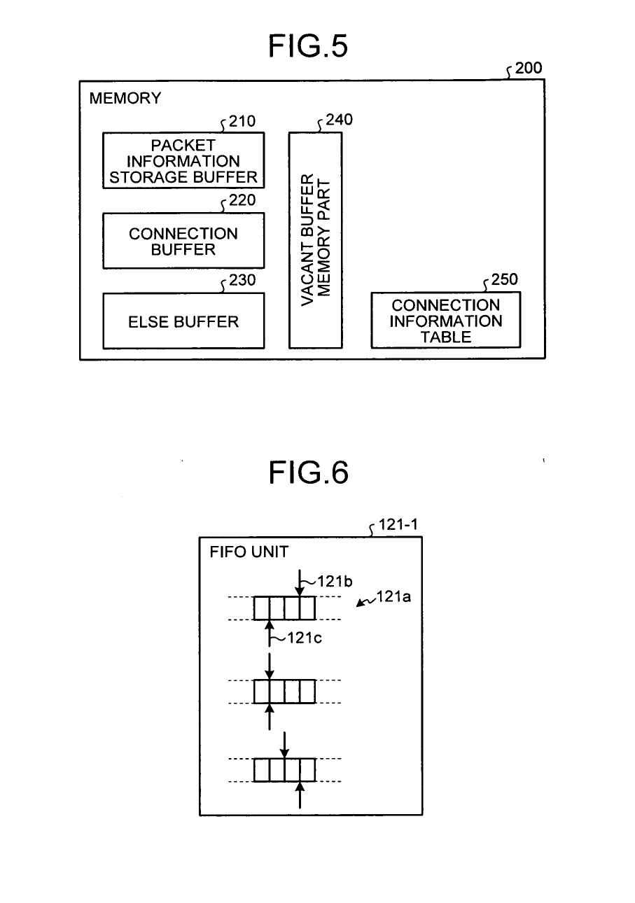

FIG. 4 and FIG. 5 are block diagrams respectively illustrating the internal configurations of the CPU section 100 and the memory 200 according to the present embodiment. The CPU section 100 illustrated in FIG. 4 includes an allocating CPU 110 and parallel processing CPUs 120-1 to 120-n (n is an integer number of two or more). The memory 200 illustrated in FIG. 5 includes a packet information storage buffer 210, a connection buffer 220, an else buffer 230, a vacant buffer memory part 240, and a connection information table 250.

In FIG. 4, the allocating CPU 110 refers to the connection information table 250 stored in the memory 200, and allocates packets to the parallel processing CPUs 120-1 to 120-n in such a manner that the packets received from the same connection are processed by the same parallel processing CPU. Moreover, the allocating CPU 110 executes the assignment and release of a buffer area that is used when the parallel processing CPUs 120-1 to 120-n execute a process for a packet. Specifically, the allocating CPU 110 includes a process allocating unit 111, a buffer assigning unit 112, a FIFO (First-In First-Out) monitoring unit 113, and a buffer releasing unit 114.

When a packet is input into the packet processing device, the process allocating unit 111 refers to the vacant buffer memory part 240 of the memory 200 to acquire a vacant buffer area of the packet information storage buffer 210 and stores the packet information of the input packet in the vacant buffer area. Then, the process allocating unit 111 refers to the connection information table 250 and decides which of the parallel processing CPUs processes the packet. In other words, when a packet received from a certain TCP (Transmission Control Protocol) connection is previously processed by the parallel processing CPU 120-1 and that information is stored in the connection information table 250, the process allocating unit 111 allocates packet processes so that all packets received from the same TCP connection are processed by the parallel processing CPU 120-1.

The buffer assigning unit 112 refers to the vacant buffer memory part 240 or the connection information table 250 of the memory 200 and assigns the buffer areas of the connection buffer 220 and the else buffer 230 that are used for the execution of the process to the parallel processing CPUs of which the processes are allocated. In other words, when the parallel processing CPU that is an allocation destination processes a packet transmitted by a newly-established connection, the buffer assigning unit 112 refers to the vacant buffer memory part 240 to acquire a vacant buffer area and assigns the vacant buffer area to the parallel processing CPU that is an allocation destination. On the other hand, when the parallel processing CPU that is an allocation destination processes a packet transmitted by the existing connection, the buffer assigning unit 112 refers to the connection information table 250 and assigns an in-use buffer area corresponding to the existing connection to the parallel processing CPU that is an allocation destination.

As a result of the process performed by the process allocating unit 111 and the buffer assigning unit 112, a process for the input packet is allocated to any of the parallel processing CPUs 120-1 to 120-n, and the packet information storage buffer 210, the connection buffer 220, and the else buffer 230, which are referred to and used in the process for a packet, are assigned to the parallel processing CPU that is an allocation destination.

The FIFO monitoring unit 113 monitors a FIFO included in each of the parallel processing CPUs 120-1 to 120-n and detects the presence or absence of a buffer area of which the use is terminated by each of the parallel processing CPUs. While the parallel processing CPUs 120-1 to 120-n store buffer position information indicating the position of a releasable buffer area in FIFO units 121-1 to 121-n to be described below when the process is completed, the FIFO monitoring unit 113 constantly monitors the FIFO units 121-1 to 121-n and confirms whether there is the releasable buffer area.

As a result of monitoring the FIFO units 121-1 to 121-n by the FIFO monitoring unit 113, when the releasable buffer area is in the packet information storage buffer 210, the connection buffer 220, or the else buffer 230, the buffer releasing unit 114 releases the corresponding buffer area and registers the buffer area in the vacant buffer memory part 240 as a vacant buffer area.

When the process for a packet is allocated and the buffer area to be used for the process is assigned by the allocating CPU 110, the parallel processing CPUs 120-1 to 120-n acquire packet information for the packet from the packet information storage buffer 210 of the memory 200 and execute a predetermined process. At this time, the parallel processing CPUs 120-1 to 120-n execute the process by using connection information or the like stored in the buffer areas of the connection buffer 220 and the else buffer 230 that are assigned by the allocating CPU 110.

The parallel processing CPUs 120-1 to 120-n respectively include the FIFO units 121-1 to 121-n. The parallel processing CPUs 120-1 to 120-n register, in the FIFO units 121-1 to 121-n, buffer position information of the buffer area of the packet information storage buffer 210 for storing packet information of the packet when the process for a packet is completed. Similarly, the parallel processing CPUs 120-1 to 120-n register, when a connection for transmitting a packet is cut by completing the process for the packet, buffer position information of the buffer area of the connection buffer 220 for storing connection information for the connection in the FIFO units 121-1 to 121-n. Similarly, also in the case of the else buffer 230, the parallel processing CPUs 120-1 to 120-n register buffer position information for the buffer area, which becomes unnecessary when the process of a packet is completed, in the FIFO units 121-1 to 121-n.

In this case, the FIFO unit 121-1 has, for example, the configuration as illustrated in FIG. 6. In other words, the FIFO unit 121-1 has FIFOs 121a that respectively correspond to the packet information storage buffer 210, the connection buffer 220, and the else buffer 230. Each of the FIFOs 121a includes a writing pointer 121b that indicates the lead position of writing and a reading pointer 121c that indicates the lead position of reading. The configuration is common to the FIFO units 121-2 to 121-n.

The FIFOs 121a can store multiple buffer position information of the corresponding buffer areas and has a circulation buffer structure in which buffer position information is stored at the last and then the next buffer position information is stored at the head. For example, in FIG. 6, although the left edge is the head of the FIFO 121a and the right edge is the end of the FIFO 121a, when buffer position information are sequentially stored from the left edge to the right edge and buffer position information is stored at the right edge, the next buffer position information is stored at the left edge that is vacant. Similarly, also in the case of the reading of buffer position information, after the last buffer position information is read, it is expected that the lead buffer position information is read.

When there is an unnecessary buffer area as when the parallel processing CPU 120-1 completes a process for a packet or when the parallel processing CPU 120-1 detects the disconnect of a connection, the writing pointer 121b indicates a position at which the parallel processing CPU 120-1 should write the buffer position information of the buffer area that is not required. Therefore, when there is a releasable buffer area, the parallel processing CPU 120-1 confirms whether the FIFO 121a has a vacant area from a positional relationship of the writing pointer 121b and the reading pointer 121c, stores the buffer position information of the releasable buffer area at the position indicated by the writing pointer 121b, and increments the writing pointer 121b. In other words, in FIG. 6, the parallel processing CPU 120-1 moves the position indicated by the writing pointer 121b in a right direction by one unit.

The reading pointer 121c indicates the position that should be monitored by the FIFO monitoring unit 113 of the allocating CPU 110. In other words, the FIFO monitoring unit 113 monitors the position indicated by the reading pointer 121c of the FIFO 121a and confirms whether buffer position information is stored in the FIFO 121a. Specifically, the FIFO monitoring unit 113 determines whether the writing pointer 121b and the reading pointer 121c are identical to each other. If these are identical to each other, the FIFO monitoring unit 113 determines that buffer storage position information is stored in the FIFO 121a. Then, when the buffer position information is stored in the FIFO 121a, the FIFO monitoring unit 113 reads out one buffer position information and increments the reading pointer 121c. In other words, in FIG. 6, the FIFO monitoring unit 113 moves the position indicated by the reading pointer 121c in a right direction by one unit.

Because the FIFO units 121-1 to 121-n that are configured in this way are accessed by only the respectively corresponding parallel processing CPUs 120-1 to 120-n or the allocating CPU 110, access conflict between the parallel processing CPUs 120-1 to 120-n does not occur. Moreover, although the individual parallel processing CPUs 120-1 to 120-n and the allocating CPU 110 access the FIFO units 121-1 to 121-n, the parallel processing CPUs 120-1 to 120-n rewrites only the writing pointer 121b and the allocating CPU 110 rewrites only the reading pointer 121c. Therefore, because accesses for rewriting performed by two CPUs are performed on only different pointers, the positions indicated by the writing pointer 121b and the reading pointer 121c do not have inconsistency. As a result, an exclusion process between the parallel processing CPUs 120-1 to 120-n and an exclusion process between the parallel processing CPUs 120-1 to 120-n and the allocating CPU 110 become unnecessary.

On the other hand, in FIG. 5, the packet information storage buffer 210 includes a plurality of buffer areas to store packet information for packets input from the interface 1 to m into the packet processing device in the buffer areas. In other words, the packet information storage buffer 210 acquires packet information for packets, which are input via a network card including a MAC unit and a PHY unit, via the internal bus 600, and stores packet information of every packet.

The connection buffer 220 includes a plurality of buffer areas to store connection information for connections through which packets are transmitted in the buffer areas. The connection information stored in the buffer areas of the connection buffer 220 is stored and referred to when the parallel processing CPUs 120-1 to 120-n execute processes for packets.

The else buffer 230 includes a plurality of buffer areas to store information in the buffer areas when the parallel processing CPUs 120-1 to 120-n execute processes for packets. The information stored in the buffer areas of the else buffer 230 is, for example, information related to a high-layer process or the like performed by the parallel processing CPUs 120-1 to 120-n.

The vacant buffer memory part 240 stores the status of vacancy for each buffer area of the packet information storage buffer 210, the connection buffer 220, and the else buffer 230. Specifically, when packet information is stored in the buffer area of the packet information storage buffer 210 by the process allocating unit 111, the vacant buffer memory part 240 stores the information indicating that the buffer area is not vacant. When the buffer areas of the connection buffer 220 and the else buffer 230 are assigned to the parallel processing CPUs 120-1 to 120-n by the buffer assigning unit 112, the vacant buffer memory part 240 stores the information indicating that the buffer areas are not vacant. When a buffer area is released by the buffer releasing unit 114, the vacant buffer memory part 240 further stores the information indicating that the buffer area is vacant.

In this way, the vacant buffer memory part 240 stores the status of vacancy of all the buffers of the memory 200. Therefore, when the allocating CPU 110 stores packet information and assigns buffer areas to the parallel processing CPUs 120-1 to 120-n, the allocating CPU 110 can easily grasp a vacant buffer area. Moreover, because only the allocating CPU 110 accesses the vacant buffer memory part 240, an exclusion process does not become necessary.

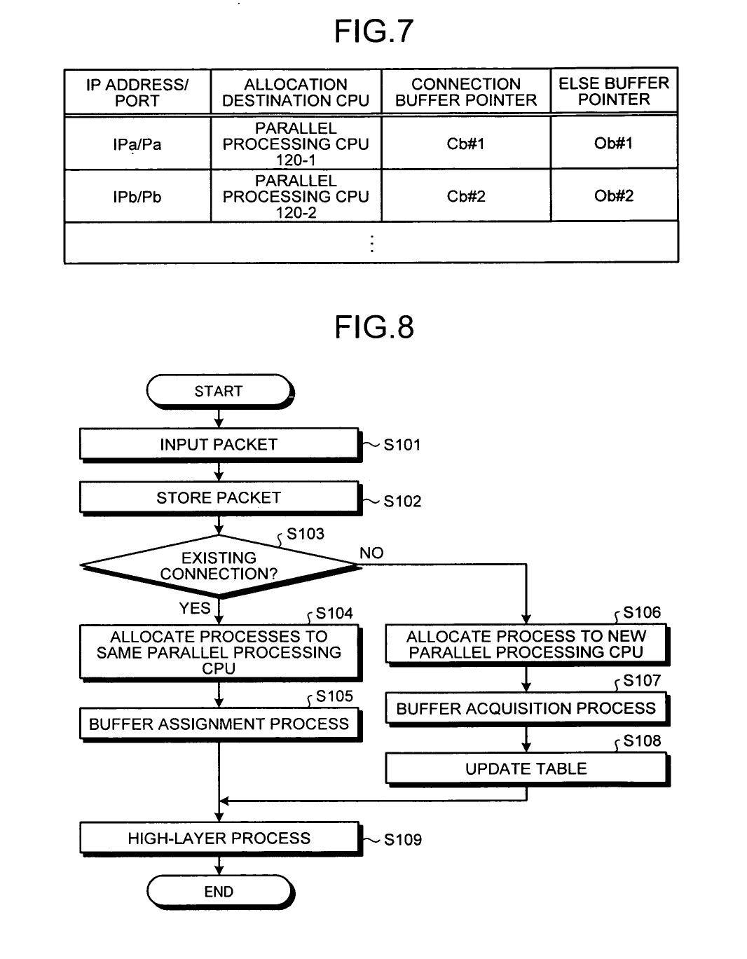

The connection information table 250 stores information for the parallel processing CPUs 120-1 to 120-n that perform a process corresponding to a connection through which a packet input into the packet processing device is transmitted and a buffer area used for the process. Specifically, as illustrated in FIG. 7, the connection information table 250 stores, in association with IP address and port according to connection, the information for the parallel processing CPUs 120-1 to 120-n that are an allocation destination, the buffer area (connection buffer pointer) of the connection buffer 220 that is being used by the parallel processing CPU that is an allocation destination, and the buffer area (else buffer pointer) of the else buffer 230 that is being used by the parallel processing CPU that is an allocation destination. In an example illustrated in FIG. 7, for example, a packet of which the IP address is “IPa” and the port is “Pa” is allocated to the parallel processing CPU 120-1. The process for the packet uses a buffer area “Cb#1” of the connection buffer 220 and a buffer area “Ob#1” of the else buffer 230.

In this case, a correspondence relationship between IP address and port, allocation destination CPU, connection buffer pointer, and else buffer pointer in the connection information table 250 is decided and registered by the allocating CPU 110 whenever a new connection is established. When packets transmitted by an existing connection are input, the packets are allocated to the parallel processing CPUs 120-1 to 120-n that are an allocation destination of a packet that is previously input from the same connection, by referring to the connection information table 250 by the process allocating unit 111 of the allocating CPU 110. Therefore, all the packets input from the same connection are processed by the same CPU of the parallel processing CPUs 120-1 to 120-n. As a result, because only one of the parallel processing CPUs 120-1 to 120-n accesses the buffer areas of the connection buffer 220 and the else buffer 230, an exclusion process becomes unnecessary.

Subsequently, it will be explained about packet input operations of the packet processing device that is configured as described above with reference to a flowchart illustrated in FIG. 8. In this case, it will be mainly explained about the operations of each CPU of the CPU section 100. The descriptions for the detailed operations of the memory control unit 300, the MAC units 400-1 to 400-m, and the PHY units 500-1 to 500-m are omitted.

First, when a packet transmitted through a connection is input into the packet processing device (operation S101), the process allocating unit 111 of the allocating CPU 110 refers to the vacant buffer memory part 240 and acquires a vacant buffer area of the packet information storage buffer 210. Then, packet information for the input packet is stored in the obtained vacant buffer area of the packet information storage buffer 210 (operation S102).

Moreover, the process allocating unit 111 confirms IP address and port from the packet information and determines whether the connection through which the packet is transmitted is an existing connection by referring to the connection information table 250 (operation S103). In other words, if the IP address and port of the packet is already registered in the connection information table 250, the process allocating unit 111 determines that the connection of the packet is an existing connection. If the IP address and port of the packet is not registered in the connection information table 250, the process allocating unit 111 determines that the connection of the packet is a new connection.

As the determination result, when the connection is an existing connection (operation 5103: Yes), the process allocating unit 111 reads an allocation destination CPU corresponding to the IP address and port of the packet from the connection information table 250 and allocates a process for the packet to the parallel processing CPU that is an allocation destination. In other words, the process for the packet is allocated to the parallel processing CPU that executes the process for the packet that is previously input from the same connection (operation S104).

Then, the buffer assigning unit 112 reads a connection buffer pointer and an else buffer pointer corresponding to the IP address and port of the packet from the connection information table 250, and executes a buffer assignment process for assigning the buffer areas of the connection buffer 220 and the else buffer 230 to the parallel processing CPU that is an allocation destination (operation S105).

On the contrary, when the connection is a new connection (operation S103: No), the process allocating unit 111 selects one vacant parallel processing CPU and decides the selected CPU as an allocation destination for the packet. In other words, a packet process is allocated to a new parallel processing CPU that is not executing a process for a packet (operation S106). Moreover, the process allocating unit 111 registers a correspondence relationship between the IP address and port of the packet and the parallel processing CPU that is an allocation destination in the connection information table 250. At this point, only the correspondence relationship between the connection and the parallel processing CPU that is an allocation destination is registered in the connection information table 250. However, the connection buffer pointer and the else buffer pointer indicating the buffer areas of the connection buffer 220 and the else buffer 230 that are used by the parallel processing CPU are not registered.

Then, the buffer assigning unit 112 refers to the vacant buffer memory part 240 and executes a buffer acquisition process for acquiring the vacant buffer areas of the connection buffer 220 and the else buffer 230 (operation S107). The vacant buffer areas acquired by the buffer acquisition process are continuously used for a high-layer process or the like that is performed by the parallel processing CPU that is the allocation destination for the packet while the connection is established. Therefore, the buffer assigning unit 112 registers the connection buffer pointer and else buffer pointer indicating a vacant buffer area in the connection information table 250 in association with the IP address and port indicating a connection (operation S108).

In this way, because the connection through which a packet is transmitted, the parallel processing CPU that executes a process for the packet, and the buffer area that is used by the parallel processing CPU are associated with one another in the connection information table 250, the process for the packet transmitted by the same connection can be allocated to the same parallel processing CPU and the same buffer area of the connection buffer 220 and the else buffer 230 can be assigned to the parallel processing CPU while the connection is continued.

Moreover, in the case of the allocation of a series of processes and the assignment and acquisition of buffer area described above, only the allocating CPU 110 executes writing accompanied with the registration of information into the vacant buffer memory part 240 and the connection information table 250. Therefore, because access conflict in the vacant buffer memory part 240 and the connection information table 250 does not occur, an exclusion process between the CPUs becomes unnecessary.

Then, when a parallel processing CPU that is an allocation destination is decided and a buffer area to be used is assigned, the parallel processing CPU executes a process such as a high-layer process for a packet (operation S109). At this time, the parallel processing CPU that is an allocation destination uses the packet information stored in the packet information storage buffer 210 and also uses the assigned buffer areas of the connection buffer 220 and the else buffer 230. Because the other parallel processing CPUs cannot access the assigned buffer areas and thus access conflict in the connection buffer 220 and the else buffer 230 does not occur, an exclusion process between the parallel processing CPUs 120-1 to 120-n becomes unnecessary.

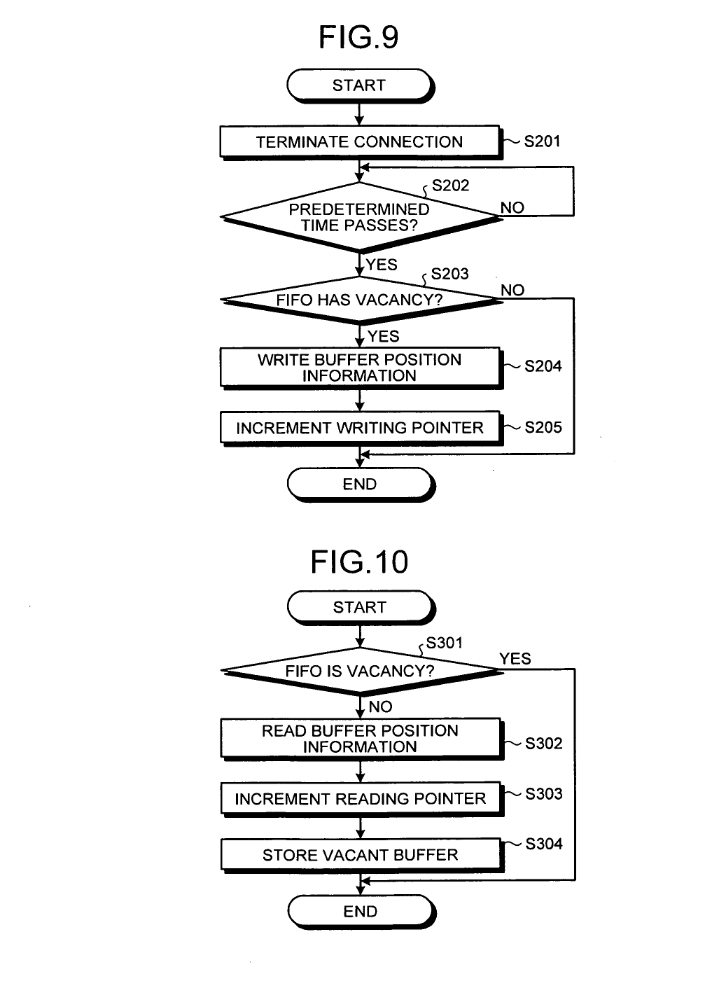

Next, it will be explained about the operations of the parallel processing CPU 120-1 when the packet process performed by the packet processing device according to the present embodiment is completed and the connection through which a packet is transmitted is cut with reference to a flowchart illustrated in FIG. 9. In this case, because the operations of the parallel processing CPUs 120-2 to 120-n are similar to the operations of the parallel processing CPU 120-1, their descriptions are omitted.

In the present embodiment, the packet information for the final packet that is transmitted through a connection includes information indicative of that effect. When the process for the final packet of the connection is executed, the parallel processing CPU 120-1 detects that the connection is terminated after the packet is transmitted (operation S201). Then, the parallel processing CPU 120-1 waits until a predetermined time passes after the termination of the connection is detected by a timer not illustrated (operation S202).

When the connection through which a packet is transmitted is surely cut after a predetermined time passes, the parallel processing CPU 120-1 determines whether the FIFO 121a of the FIFO unit 121-1 has a vacancy (operation S203). Specifically, the parallel processing CPU 120-1 refers to the writing pointer 121b and the reading pointer 121c that are added to the FIFO 121a corresponding to each of the packet information storage buffer 210, the connection buffer 220, and the else buffer 230, and determines that the FIFO 121a does not have a vacancy when the reading pointer 121c is larger than the writing pointer 121b by one unit. In other words, because the FIFO 121a becomes full when one-unit information is written from the writing pointer 121b into the FIFO 121a, the parallel processing CPU 120-1 determines that there is not a vacancy like the above.

Then, when the FIFO 121a does not have a vacancy (operation S203: No), the parallel processing CPU 120-1 does not release the buffer area of the connection buffer 220 and the buffer area of the else buffer 230 that store connection information for the terminated connection, and terminates the process and waits at this point.

On the other hand, when the FIFO 121a has a vacancy (operation S203: Yes), the parallel processing CPU 120-1 writes the buffer position information of the buffer area that stores packet information for the packet of which the process completed and the buffer area that stores connection information for the terminated connection and the other information at the position of the writing pointer 121b (operation S204). At the same time, the parallel processing CPU 120-1 increments the writing pointer 121b of each of the FIFOs 121a at which the buffer position information is written by one unit (operation S205).

In this way, when the parallel processing CPU 120-1 completes the process for a packet and terminates the connection, the buffer position information of the buffer area that stores information related to the packet and connection is stored in the FIFO unit 121-1. At this time, because the parallel processing CPU 120-1 accesses only the FIFO unit 121-1 and does not access the FIFO units 121-2 to 121-n of the other parallel processing CPUs 120-2 to 120-n, an exclusion process between the parallel processing CPUs 120-1 to 120-n is unnecessary. Because the FIFO units 121-1 to 121-n that store the buffer position information of the buffer area that is not required are referred to by the allocating CPU 110, the buffer area that stores information that is not required can be released.

Next, it will be explained about an operation for releasing the buffer area of the allocating CPU 110 according to the present embodiment with reference to a flowchart illustrated in FIG. 10.

In the present embodiment, the FIFO monitoring unit 113 of the allocating CPU 110 constantly monitors the FIFO units 121-1 to 121-n of the parallel processing CPUs 120-1 to 120-n (operation S301). Specifically, the FIFO monitoring unit 113 compares the writing pointer 121b and the reading pointer 121c in each of the FIFOs 121a and monitors whether both are identical to each other and the FIFO 121a is vacant. Then, if all the FIFO units 121-1 to 121-n are vacant and the buffer position information of the buffer area to be released is not stored (operation S301: No), the process is terminated without releasing any of the buffer areas.

On the other hand, if any of the FIFO units 121-1 to 121-n is not vacant and the buffer position information of the buffer area to be released is stored (operation 5301: Yes), the FIFO monitoring unit 113 reads buffer position information from the position of the reading pointer 121c in each of the FIFOs 121a (operation S302). At the same time, the FIFO monitoring unit 113 increments the reading pointer 121c in each of the FIFOs 121a by units by which the buffer position information is read (operation S303).

When the buffer position information of the buffer area to be released is read from the FIFO units 121-1 to 121-n, the buffer releasing unit 114 performs a process for releasing the buffer areas of the packet information storage buffer 210, the connection buffer 220, and the else buffer 230 that are indicated by the read buffer position information. Moreover, the buffer releasing unit 114 stores the information indicating that the buffer areas are a vacant buffer area in the vacant buffer memory part 240 (operation S304).

As a result, the buffer area that stores packet information or connection information that becomes unnecessary by the termination of connection is released to become a vacant buffer area. When a new connection is established, the vacant buffer area is used to store packet information or connection information of a packet that is transmitted through the connection. In this case, the buffer area of the packet information storage buffer 210 is released in a manner similar to the above whenever the process performed by the parallel processing CPUs 120-1 to 120-n is completed. On the other hand, the buffer areas of the connection buffer 220 and the else buffer 230 are released only when a connection is terminated as described above because the buffer areas are referred to by the parallel processing CPUs 120-1 to 120-n while the connection is continued.

In this way, when the buffer position information of the buffer area to be released is stored in the FIFO units 121-1 to 121-n, the allocating CPU 110 releases the buffer area. At this time, although the allocating CPU 110 accesses the FIFO units 121-1 to 121-n, only the reading pointer 121c is actually rewritten. Then, because each of the parallel processing CPUs 120-1 to 120-n rewrites only the writing pointer 121b, an exclusion process between the parallel processing CPUs 120-1 to 120-n and the allocating CPU 110 is unnecessary.

As described above, according to the present embodiment, the allocating CPU 110 allocates a packet process to the parallel processing CPUs 120-1 to 120-n and also performs an acquisition process or an assignment process on the buffer area that is used for the process. Moreover, when the processes of the parallel processing CPUs 120-1 to 120-n are completed, the parallel processing CPUs 120-1 to 120-n respectively register buffer areas to be released in the FIFO units 121-1 to 121-n and the allocating CPU 110 performs a release process on the buffer areas. For this reason, in the case of the assignment and release of a buffer area, only the allocating CPU 110 can access buffer management information and a plurality of CPUs does not access the information. Therefore, an exclusion process becomes unnecessary even in the case of the assignment and release of a buffer. It is possible to reduce the frequency of an exclusion process between CPUs to improve a performance when the plurality of CPUs concurrently executes processes for packets.

In the embodiment, although it has been explained about the case where the allocating CPU 110 is included in the packet processing device, the present invention is not limited to this. When a general computer includes a plurality of general-purpose CPUs, the computer introduces therein a program for making one CPU execute a process similar to that of the embodiment so that the computer can be activated similarly to the embodiment.

The embodiment prevents access conflict in the connection buffer 220 and the else buffer 230 to remove an exclusion process by allocating packet processes to the parallel processing CPUs 120-1 to 120-n every connection. However, in a service such as FTP (File Transfer Protocol) that simultaneously uses two connections of a control connection and a data connection, it may be necessary that one parallel processing CPU refers to connection information for a plurality of connections.

The control connection used in FTP is used for the transmission of control information such as a list or a status of a transfer file and the data connection is used for the transmission of a file that is actually uploaded or downloaded. In a so-called passive mode of FTP, the data connection corresponding to the control connections is specified by referring to control information transmitted by the control connection. Therefore, a parallel processing CPU that executes a process on a file transmitted by the data connection uses both of connection information of the control connection and connection information of the data connection.

Specifically, as an example of a QoS (Quality of Service) process in FTP, it is necessary to restrict the bandwidth of the sum of a control connection and a data connection to 10 Mbps when the bandwidth of FTP is set to be controlled to 10 Mbps. At this time, in a mode other than a passive mode, a destination port corresponding to the control connection is usually fixed to the 21st port and a destination port corresponding to the data connection is usually fixed to the 20th port. However, because a port for the data connection is not fixed in a passive mode, the data connection is established at a port that is designated by a server through the control connection. For this reason, when the packet processing device according to the present invention relays traffic of FTP, the packet processing device cannot determine whether a connection is the data connection of FTP from a destination port number, and thus it is necessary to refer to control information transmitted by the control connection of FTP.

In other words, it is necessary that a parallel processing CPU to which a process related to the control connection of FTP is allocated confirms a port number of the data connection corresponding to the control connection and stores a correspondence between the control connection and the data connection as connection information in a connection buffer. When processes related to a control connection and a data connection corresponding to each other are allocated to different parallel processing CPUs, the plurality of parallel processing CPUs accesses the connection buffer that stores connection information and thus an exclusion process becomes necessary. Therefore, it is necessary that the same parallel processing CPU performs a process on a control connection and a data connection that correspond to each other.

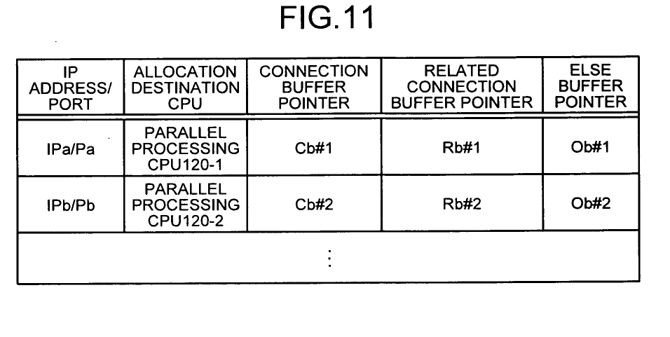

To realize this, the connection information table 250 stored in the memory 200 is, for example, configured as illustrated in FIG. 11. In other words, a related connection buffer pointer is added as the position of the buffer area of the connection buffer 220 that is used by the parallel processing CPUs 120-1 to 120-n. This means that connection information of both of a control connection and a data connection corresponding to the parallel processing CPUs 120-1 to 120-n is referred to. Therefore, the related connection buffer pointer is not registered as for a normal connection other than FTP.

Furthermore, FIFOs for related connection notification are respectively and newly arranged in the FIFO units 121-1 to 121-n of the parallel processing CPUs 120-1 to 120-n. When the parallel processing CPUs 120-1 to 120-n to which processes corresponding to a control connection are allocated grasp IP address and port of a data connection from the control information transmitted by the control connection, the parallel processing CPUs 120-1 to 120-n store information for IP address and port of the control connection and the data connection corresponding to each other in the FIFOs for related connection notification.

When such a configuration is employed, the FIFO monitoring unit 113 of the allocating CPU 110 monitors the FIFOs for related connection notification. If information for IP address and port of the related connection is stored, the FIFO monitoring unit 113 reads out the information and confirms an allocation destination CPU corresponding to the control connection from the connection information table 250. Then, the FIFO monitoring unit 113 registers the allocation destination CPU, the connection buffer pointer, the related connection buffer pointer, and the else buffer pointer in the connection information table 250 in association with the data connection. However, in this case, it is assumed that the allocation destination CPU of the data connection is the same parallel processing CPU as the allocation destination CPU corresponding to the control connection. Moreover, it is assumed that the related connection buffer pointer of the data connection is a connection buffer pointer corresponding to the control connection.

As a result, a process related to a data connection is allocated to a parallel processing CPU that performs a process related to the corresponding control connection. Moreover, when the allocating CPU 110 allocates a process related to a data connection, the buffer area of the connection buffer 220 that stores connection information of the control connection corresponding to the data connection can be specified by referring to the related connection buffer pointer of the connection information table 250. Therefore, a parallel processing CPU to which the processes of both of the control connection and the data connection are allocated can execute the processes while referring to the connection information for both connections. In addition, because the processes related to the control connection and the data connection corresponding to each other are allocated to the same parallel processing CPU, the plurality of CPUs does not access the connection information of the control connection and data connection. As a result, an exclusion process between the parallel processing CPUs becomes unnecessary.

According to an aspect of the present invention, because the allocating processor allocates processing target packets and assigns buffer areas required for the process to the plurality of processing processors, the plurality of processing processors that concurrently executes the process need not access a buffer to acquire each buffer area and thus an exclusion process between the plurality of processing processors is not required. In other words, when the plurality of CPUs concurrently executes a process for a packet, it is possible to reduce the frequency of an exclusion process between the CPUs to improve a performance.

According to an aspect of the present invention, because each of the plurality of processing processors corresponds to one connection and the allocation to the processing processors is performed in accordance with the connection used for the transmission of a packet, an exclusion process between the plurality of processing processors can be surely reduced without the conflict of access to each connection information when each processing processor performs the process on a packet.

According to an aspect of the present invention, because a correspondence relationship between the connection used for the transmission of a packet and the buffer area used for the process of the packet is stored and the same buffer area is assigned to a packet transmitted by the same connection, an exclusion process between the plurality of processing processors can be surely reduced without sharing the information stored in each buffer area by the plurality of processing processors.

According to an aspect of the present invention, when a plurality of connections is associated with each other, because the packets transmitted by the connections are allocated to the same processing processor and the associated buffer area is assigned to the processing processor, one processing processor accesses a buffer area that stores information for connections that are associated with each other even if a packet is transmitted by a protocol that uses two connections of a control connection and a data connection, and thus an access competition caused by the plurality of processing processors can be prevented.

According to an aspect of the present invention, because the queue of each processing processor stores the buffer position information for the buffer area of which the use is terminated, each processing processor can easily inform the other processors of a releasable buffer area.

According to an aspect of the present invention, because the allocating processor monitors the queue to release the buffer area indicated by the buffer position information, only the allocating processor releases the buffer area and thus the access competition to the buffer performed by the plurality of processing processors can be prevented when releasing the buffer area.

According to an aspect of the present invention, because the writing pointer referred to by the processing processor and the reading pointer referred to by the allocating processor are included, the processing processor accesses only the writing pointer and the allocating processor accesses only the reading pointer when accessing the queue that stores the buffer position information, and thus an access competition in the queue can be prevented.

According to an aspect of the present invention, because the allocating processor allocates a processing target packet and assigns a buffer area required for the process to the plurality of processing processors, the plurality of processing processors, which concurrently executes the process, does not access the buffer to acquire the buffer area, and thus an exclusion process between the plurality of processing processors is not required. In other words, when the plurality of CPUs concurrently executes a process for a packet, it is possible to reduce the frequency of an exclusion process between the CPUs to improve the performance.

As described above, according to an aspect of the present invention, when the plurality of CPUs concurrently executes a process for a packet, it is possible to reduce the frequency of an exclusion process between the CPUs to improve the performance.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A packet processing device comprising:
a memory unit that includes a plurality of areas each corresponding to a type of communication that is used for transmission of a packet;
a plurality of processing units that is provided in correspondence with the type of communication and performs a process on the packet;
an allocating unit that allocates a processing target packet to the processing unit corresponding to the type of communication that is used for transmission of the processing target packet;
an assigning unit that assigns the area corresponding to the type of communication that is used for transmission of the processing target packet to the processing unit to which the processing target packet is allocated; and
a storage unit that stores information on the process of the processing target packet and information on the type of communication that is used for transmission of the processing target packet in the assigned area.

2. The packet processing device according to claim 1, wherein
the memory unit further stores, in association with each other, the processing unit to which the processing target packet is allocated, a buffer area that is being used by the processing unit, and a connection that is used for transmission of the processing target packet, and stores a vacant buffer area that is not used by the processing units, and
the allocating unit assigns, to a processing unit that corresponds to an existing connection, a buffer area that is being used by the processing unit and assigns a vacant buffer area to a processing unit that corresponds to a new connection.

3. The packet processing device according to claim 1, wherein
the memory unit further stores, in association with each other, a related buffer area that is being used by a processing unit corresponding to a related connection, which is a connection related to the connection that is used for transmission of the processing target packet, and the connection that is used for transmission of the processing target packet and
the allocating unit allocates, when the connection that is used for transmission of the processing target packet has the related connection, the processing target packet to the processing unit corresponding to the related connection and assigns the related buffer area to the processing unit.

4. The packet processing device according to claim 1, wherein each of the plurality of processing units includes a queue that stores buffer position information indicating a position of a buffer area of which a use is terminated.

5. The packet processing device according to claim 1, wherein the allocating unit includes:
a monitoring unit that monitors the queue included in each of the plurality of processing units; and
a releasing unit that reads, when the buffer position information is stored in the queue as a result of monitoring performed by the monitoring unit, the buffer position information from the queue and releases a buffer area indicated by the buffer position information.

6. The packet processing device according to claim 1, wherein the queue includes a writing pointer that indicates a position at which each of the plurality of processing units stores the buffer position information and a reading pointer that indicates a position at which the allocating unit reads out the buffer position information.

7. A method for processing packets in a packet processing device comprising:
allocating a processing target packet to one of a plurality of processing units corresponding to a type of communication that is used for transmission of a processing target packet, the plurality of processing units being provided in correspondence with the type of communication and performs a process on the packet;
assigning one of a plurality of areas in a memory unit corresponding to the type of communication that is used for transmission of the processing target packet to the processing unit to which the processing target packet is allocated, each of the plurality of areas in the memory unit corresponding to a type of communication that is used for transmission of a packet; and
storing information on a process of the processing target packet and information on the type of communication that is used for transmission of the processing target packet in the assigned area.
